(19) United States
(12) Patent Application Publication
(10) Pub. No.: US 2025/0067872 A1
(43) Pub. Date: Feb. 27, 2025

(54) RANGING DEVICE AND METHOD OF DRIVING RANGING DEVICE

(71) Applicant: CANON KABUSHIKI KAISHA, Tokyo (JP)

(72) Inventors: TAKURO YAMAMOTO, Kanagawa (JP); SHOGO YAMASAKI, Kanagawa (JP)

(21) Appl. No.: 18/798,464

(22) Filed: Aug. 8, 2024

(30) Foreign Application Priority Data
Aug. 23, 2023 (JP) 2023-135577

(51) Int. Cl. G01S 17/89; G01S 17/04; H04N 25/46

(52) U.S. Cl. CPC G01S 17/89; G01S 17/04; H04N 25/46

(57) ABSTRACT

A ranging device includes a light receiving unit including a plurality of pixels that detects light including an irradiation light reflected by an object, a binning processing unit that converts signals of the plurality of pixels into signals of pixel blocks, an information generation unit that generates information in which each of the signals of the pixel blocks generated by the binning processing unit and a time from light emission to light detection are associated with each other, and a data transfer that transfers the plurality of signals from the light receiving unit to the binning processing unit. The data transfer unit sequentially transfers the plurality of signals received from the light receiving unit to the binning processing unit, and the binning processing unit sequentially converts the plurality of signals transferred from the data transfer unit into the signals of the pixel blocks.

### BACKGROUND

### Technical Field

The present invention relates to a ranging device and a method of driving a ranging device.

### Description of the Related Art

As one of the distance measurement techniques, there is a technique of irradiating a predetermined range including a distance measurement target object with light from a surface light source to detect reflected light from the distance measurement target object, and measuring a distance to the target object from a relationship between a light emission timing of the surface light source and a detection timing of the reflected light from the target object. This technology is called flash LiDAR (Light Detection And Ranging).

In the flash LiDAR, the surface light source emits light a plurality of times to integrate the reflected light, thereby improving the distance measurement accuracy. The integration of the reflected light is performed by generating histogram information representing the relationship between the distance and the frequency, but the memory capacity required for the signal processing increases in proportion to the increase in the number of pixels of the light receiving unit. Therefore, it has been proposed to reduce a memory capacity required for signal processing by performing a process of collectively handling a plurality of pixels as one pixel, that is, a so-called binning processing. Japanese Patent Application Laid-Open No. 2020-118570 proposes to reduce a memory capacity required for processing by adding signal information of adjacent pixels. U.S. Patent Application Publication No. 2020/0058698 proposes to reduce the required memory capacity by storing in a memory after compression determination.

However, in the technologies described in Japanese Patent Application Laid-Open No. 2020-118570 and U.S. Patent Application Publication No. 2020/0058698, it is necessary to provide an addition circuit and a compression determination circuit for each unit of pixels for which addition and compression determination are to be performed, and an increase in circuit scale cannot be avoided.

### SUMMARY OF THE INVENTION

An object of the present invention is to provide a ranging device and a method of driving the ranging device capable of improving distance measurement accuracy while suppressing an increase in memory capacity and processing circuitry required for signal processing.

According to one disclosure of the present specification, there is provided a ranging device including a light receiving unit including a plurality of pixels configured to detect light including an irradiation light from a light emitting unit reflected by an object in a measurement target region, a binning processing unit configured to convert a plurality of signals output from the plurality of pixels into signals of pixel blocks each including a part of the plurality of pixels, an information generation unit configured to generate information in which each of the signals of the pixel blocks generated by the binning processing unit and a time from light emission of the light emitting unit to light detection are associated with each other, and a data transfer unit configured to transfer the plurality of signals from the light receiving unit to the binning processing unit, wherein the data transfer unit is configured to sequentially transfer the plurality of signals received from the light receiving unit to the binning processing unit, and wherein the binning processing unit is configured to sequentially convert the plurality of signals transferred from the data transfer unit into the signals of the pixel blocks.

According to another disclosure of the present specification, there is provided a method of driving a ranging device including a light receiving unit including a plurality of pixels configured to detect light including an irradiation light from a light emitting unit reflected by an object in a measurement target region, a binning processing unit configured to convert a plurality of signals output from the plurality of pixels into signals of pixel blocks each including a part of the plurality of pixels, and an information generation unit configured to generate information in which each of the signals of the pixel blocks generated by the binning processing unit and a time from light emission of the light emitting unit to light detection are associated with each other, the method including receiving the plurality of signals from the light receiving unit, sequentially transferring the plurality of signals received from the light receiving unit to the binning processing unit, and sequentially converting the plurality of signals to be transferred to the binning processing unit to the signals for each of the pixel blocks.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a ranging device according to a first embodiment of the present invention.

FIG. 2 is a diagram illustrating a configuration example of a light receiving unit, a data transfer unit, and a binning processing unit in the ranging device according to the first embodiment of the present invention.

FIG. 3 is a timing chart illustrating a basic operation of the ranging device according to the first embodiment of the present invention.

FIG. 4A, FIG. 4B, FIG. 4C, and FIG. 4D are diagrams illustrating a method of acquiring distance information in the ranging device according to the first embodiment of the present invention.

FIG. 5 is a flowchart illustrating a method of driving the ranging device according to the first embodiment of the present invention.

FIG. 6 is a diagram illustrating an operation example of the binning processing unit in the ranging device according to the first embodiment of the present invention.

FIG. 7 is a diagram illustrating a configuration example of a binning processing unit in a ranging device according to a second embodiment of the present invention.

FIG. 8 is a diagram illustrating a configuration example of a light receiving unit, a data transfer unit, and a binning processing unit in a ranging device according to a third embodiment of the present invention.

FIG. 9A and FIG. 9B are diagrams illustrating a configuration example of a movable object according to a fourth embodiment of the present invention.

### DESCRIPTION OF THE EMBODIMENTS

Preferred embodiments of the present disclosure will now be described in detail in accordance with the accompanying drawings. Note that the following embodiments do not limit the present invention in the scope of claims, and not all combinations of features described in the embodiments are essential to the solution of the present invention.

### First Embodiment

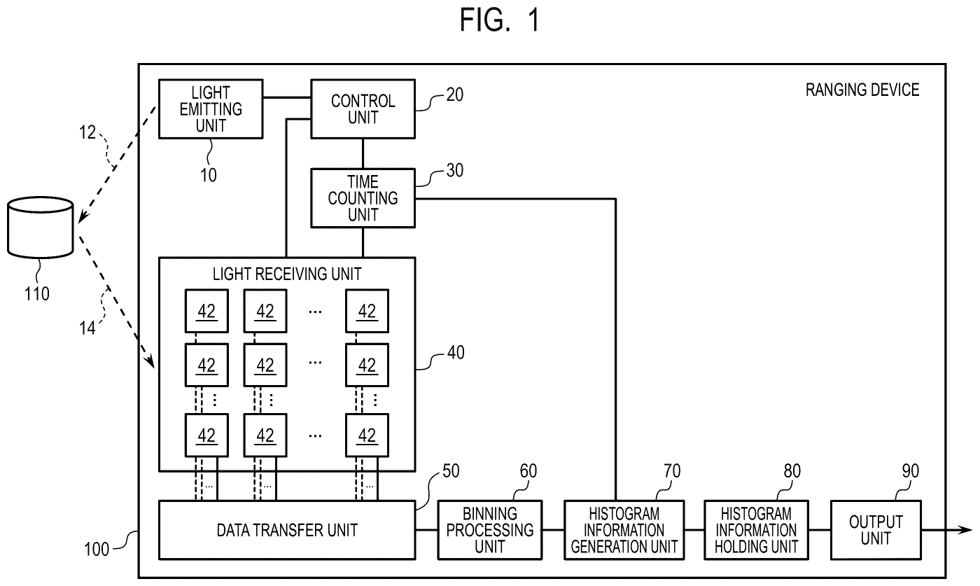

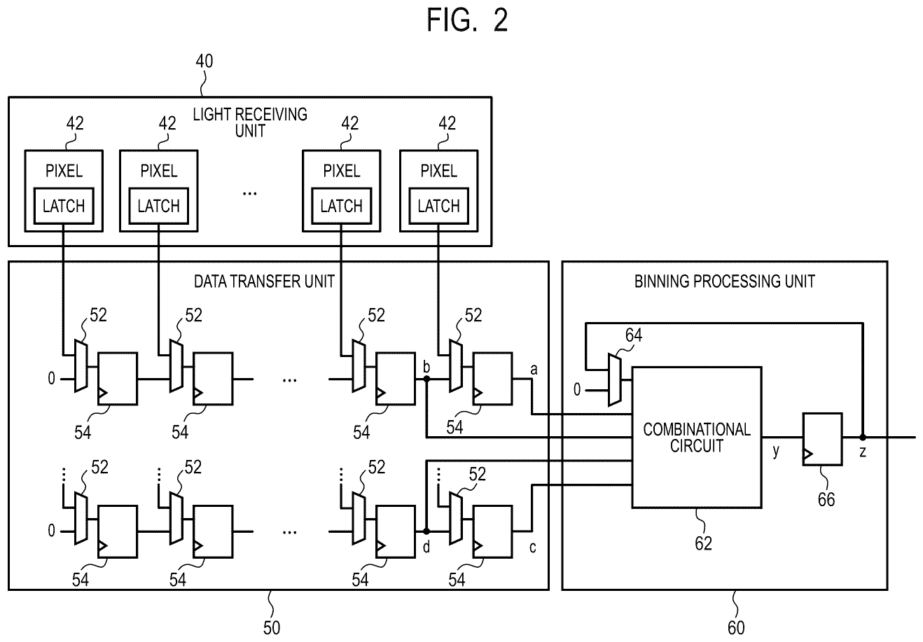

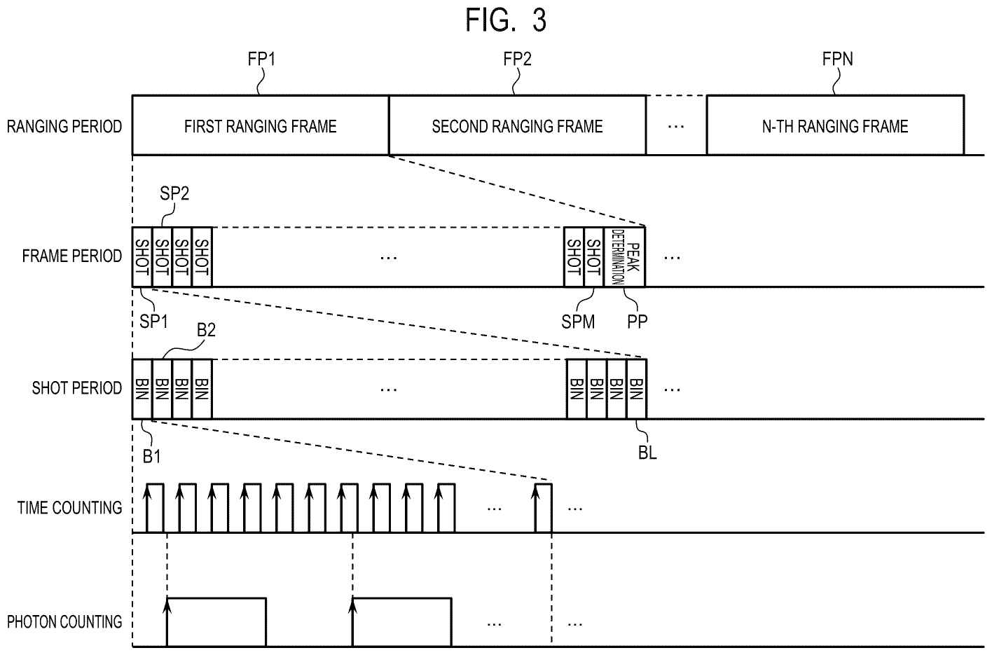

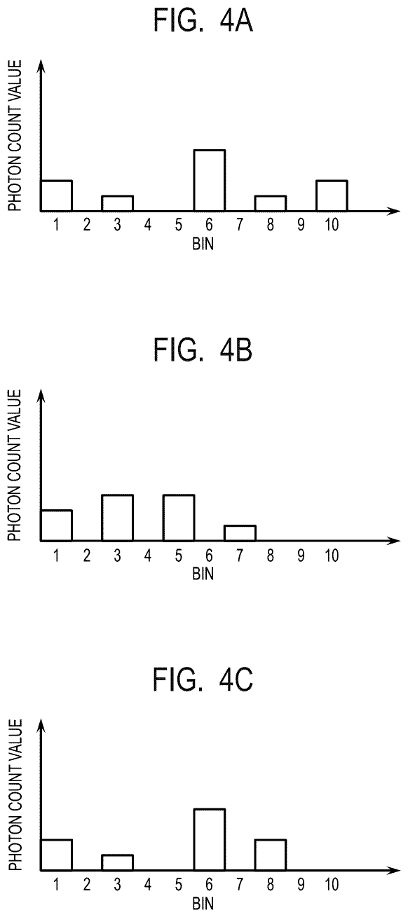

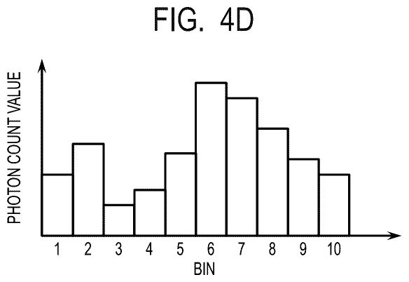

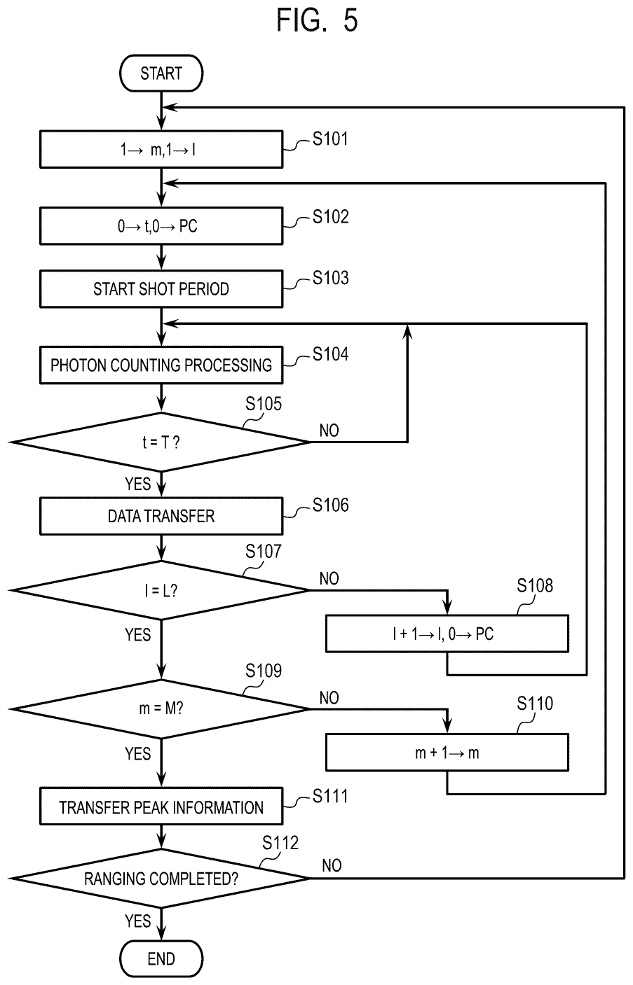

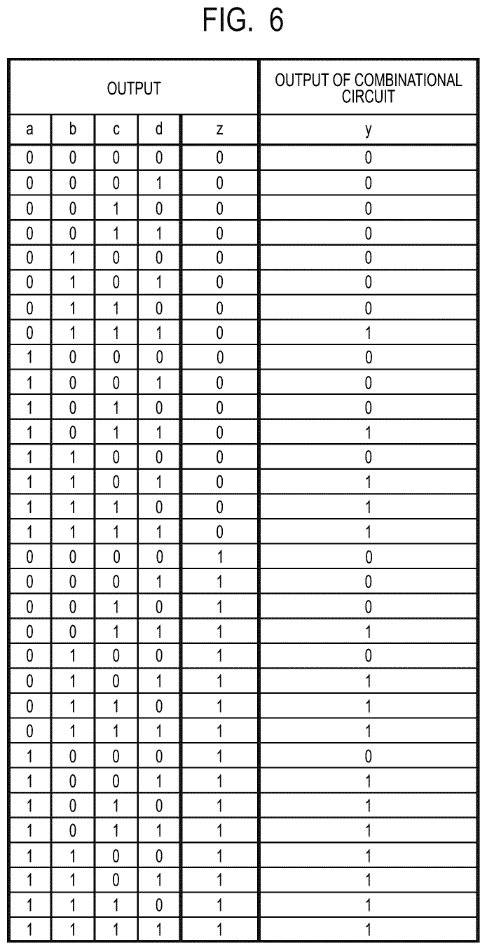

A ranging device and a ranging method according to a first embodiment of the present invention will be described with reference to FIG. 1 to FIG. 6. FIG. 1 is a block diagram illustrating a schematic configuration of a ranging device according to the present embodiment. FIG. 2 is a diagram illustrating a configuration example of a light receiving unit, a data transfer unit, and a binning processing unit in the ranging device according to the present embodiment. FIG. 3 is a timing chart illustrating a basic operation of the ranging device according to the present embodiment. FIG. 4A to FIG. 4D are diagrams illustrating a method of acquiring distance information in the ranging device according to the present embodiment. FIG. 5 is a flowchart illustrating a method of driving the ranging device according to the present embodiment. FIG. 6 is a diagram illustrating an operation example of the binning processing unit in the ranging device according to the present embodiment.

First, a schematic configuration of a ranging device according to the present embodiment will be described with reference to FIG. 1. As illustrated in FIG. 1, a ranging device 100 according to the present embodiment includes a light emitting unit 10, a control unit 20, a time counting unit 30, a light receiving unit 40, a data transfer unit 50, a binning processing unit 60, a histogram information generation unit 70, a histogram information holding unit 80, and an output unit 90. The light receiving unit 40 includes a plurality of pixels 42 two-dimensionally arranged over a plurality of rows and a plurality of columns.

The control unit 20 is connected to the light emitting unit 10, the time counting unit 30, and the light receiving unit 40. The time counting unit 30 is connected to the light receiving unit 40 and the histogram information generation unit 70. Each of the plurality of pixels 42 constituting the light receiving unit 40 is connected to the data transfer unit 50. The data transfer unit 50 is connected to the binning processing unit 60. The binning processing unit 60 is connected to the histogram information generation unit 70. The histogram information generation unit 70 is connected to the histogram information holding unit 80. The histogram information holding unit 80 is connected to the output unit 90.

The light emitting unit 10 includes a light emitting element (not illustrated), and has a role of emitting pulsed light (irradiation light 12) such as laser light emitted from the light emitting element to a measurement target region. As the light emitting element constituting the light emitting unit 10, for example, an element capable of high-speed modulation such as an LED (Light Emitting Diode) or an LD (Laser Diode) may be applied. The light emitting element may be VCSEL (Vertical Cavity Surface Emitting Laser) or a surface light emitting element in which the VCSELs are arranged in an array. The light emitting unit 10 is preferably configured to emit light of a uniform amount to the measurement target region, and may further include an optical element, for example, a lens, for optically converting the light emitted from the light emitting element to irradiate the measurement target region.

The light receiving unit 40 has a role of detecting light incident from the measurement target region. The light incident on the light receiving unit 40 includes not only the environmental light in the measurement target region but also light (reflected light 14) of the irradiation light 12 reflected by the target object 110 in the measurement target region. Each of the plurality of pixels 42 disposed in the light receiving unit 40 includes a photoelectric conversion element, converts incident light (optical signal) into an electrical signal (pulse signal), and counts pulse signals generated during a predetermined period. The counting result is held as a pixel value in each pixel 42. As the pixel 42, for example, a SPAD (Single Photon Avalanche Diode) sensor, a CMOS (Complementary Metal Oxide Semiconductor) sensor, or the like may be applied. The light receiving unit 40 may further include an optical element, such as a lens, for efficiently guiding the reflected light 14 to the pixels 42.

The control unit 20 generates a light emission control signal for controlling the light emission timings of the pulsed light in the light emitting unit 10, and transmits the generated light emission control signal to the light emitting unit 10. Further, the control unit 20 generates a count control signal synchronized with the light emission control signal, and transmits the generated count control signal to the time counting unit 30. The control unit 20 notifies the light receiving unit 40, the binning processing unit 60, the histogram information generation unit 70, and the histogram information holding unit 80 of respective processing timings.

The time counting unit 30 starts time counting in response to a count control signal from the control unit 20, and counts up the time count value by 1 at regular time intervals. The time counting unit 30 sequentially transmits the time count value to the histogram information generation unit 70.

The data transfer unit 50 has a role of transferring pixel values held by each of the plurality of pixels 42 of the light receiving unit 40 to the binning processing unit 60. Specifically, the data transfer unit 50 collectively and in parallel receives data of the pixel values from the plurality of pixels 42 of the light receiving unit 40 at a predetermined timing, and sequentially transfers the received pixel values to the subsequent binning processing unit 60 at a constant clock cycle.

The binning processing unit 60 is a functional block that performs a process of combining signals from two or more pixels as a signal from one larger pixel block, that is, a so-called pixel binning processing. Specifically, the binning processing unit 60 performs binning processing on the data of the pixel values sent from the data transfer unit 50 at a constant clock cycle, and sequentially converts the data into a signal for each pixel block including a part of pixels among a plurality of pixels constituting the light receiving unit 40. In the present embodiment, a case where the composition processing of the pixel signals in the binning processing is the compression processing is described as an example, but the binning processing is not limited to the compression processing. Details of the binning processing will be described later.

The histogram information generation unit 70 generates, based on the signals from the binning processing unit 60 and the time counting unit 30, information in which the signal for each pixel block and the time from the light emission of the light emitting unit 10 to the detection of light are associated with each other. This information is obtained by integrating the output data from the binning processing unit 60 at every predetermined time interval. Since this information represents the relationship between the class of time (hereinafter referred to as “bin”) and the frequency in each bin, this information is regarded as a histogram representing the relationship between the class and the frequency and is referred to as histogram information in this specification. The histogram information may be information in which a class and a frequency are associated with each other, and the data configuration thereof does not need to be the histogram itself. Here, the frequency is a value indicating the number of times the pixel block detects light at a predetermined time interval, and corresponds to a photon count value to be described later.

The histogram information holding unit 80 includes a storage device such as a memory, and holds the histogram information generated by the histogram information generation unit 70.

The output unit 90 may output the histogram information held by the histogram information holding unit 80 to an external processing device (not illustrated). Alternatively, the output unit 90 may calculate distance information to the target object 110 based on histogram information held by the histogram information holding unit 80, converts the distance information into a format conforming to an output format, and then outputs the distance information to an external processing device (not illustrated).

Next, a more specific configuration example of the light receiving unit 40, the data transfer unit 50, and the binning processing unit 60 in the ranging device according to the present embodiment will be described with reference to FIG. 2.

As described above, the light receiving unit 40 is provided with a plurality of pixels 42 arranged over the plurality of rows and the plurality of columns. The plurality of pixels 42 are divided into the plurality of groups. The grouping of the pixels 42 is not particularly limited, but may be performed in units of rows and columns, for example. For example, a group may be configured for each row, or a group may be configured for each column. Each row or each column may include two or more groups. In the present embodiment, it is assumed that a plurality of pixels 42 constitute one group for each row. FIG. 2 illustrates four pixels 42 arranged at both ends of a certain row among the pixels 42 of the certain row constituting one group.

The data transfer unit 50 includes a plurality of selectors 52 and a plurality of sequential circuits 54 corresponding to the plurality of pixels 42 of the light receiving unit 40. The binning processing unit 60 includes a combinational circuit 62, a selector 64, and a sequential circuit 66. Each of the selectors 52 and 64 includes two input terminals and one output terminal, select a signal input to one of the two input terminals, and output the selected signal from the output terminal. Each of the sequential circuits 54 and 66 is a circuit whose output state is determined by a combination of an external input signal and a held internal state, and may be configured by, for example, a D-type flip-flop. Each of the sequential circuits 54 and 66 includes an input terminal, an output terminal, and a clock terminal, holds a signal of the input terminal in accordance with a transition timing of a clock signal input to the clock terminal, and continuously outputs the held signal from the output terminal. The sequential circuits 54 and 66 may also be referred to as signal holding units. The combinational circuit 62 includes five input terminals and one output terminal, and outputs a signal corresponding to signals input from the five input terminals from the output terminal.

Each of the plurality of pixels 42 includes a latch circuit that temporarily holds a pixel value. The latch circuit of the pixel 42 is connected to one input terminal of the selector 52 corresponding to the pixel 42. An output terminal of the selector 52 is connected to an input terminal of a sequential circuit 54 corresponding to the pixel 42. The plurality of sequential circuits 54 corresponding to the pixels 42 constituting one group are connected in series via the selector 52. That is, the output terminal of the sequential circuit 54 is connected to the other input terminal of the selector 52 corresponding to the pixel 42 of the adjacent column in the same row.

Thus, the plurality of sequential circuits 54 corresponding to the pixels 42 constituting one group may be connected so as to form a shift register. Similarly, the plurality of sequential circuits 54 corresponding to the pixels 42 (not illustrated) constituting another group may be connected so as to form another shift register. FIG. 2 illustrates two shift registers corresponding to two groups.

Among the sequential circuits 54 constituting the data transfer unit 50, the output terminals of the sequential circuits of the predetermined number that is set according to the binning processing in the binning processing unit 60 are connected to the input terminals of the combination circuit 62. In the present embodiment, output terminals of two sequential circuits 54 on the downstream side of each shift register are connected to the input terminals of the combinational circuit 62. An output terminal of the combinational circuit 62 is connected to an input terminal of the sequential circuit 66. An output terminal of the sequential circuit 66 is connected to one input terminal of the selector 64. An output terminal of the selector 64 is connected to the input terminal of the combinational circuit 62. The output terminal of the sequential circuit 66 is also an output terminal of the binning processing unit 60. The other input terminal of the selector 64 is supplied with a signal at a level corresponding to the pixel value 0.

FIG. 3 is a timing chart illustrating a basic operation of the ranging device according to the present embodiment. In a ranging period of the ranging device according to the present embodiment, as in a ranging period of a general LiDAR system, a frame period FP of a predetermined length is sequentially performed a plurality of times. In FIG. 3, it is assumed that N-number of frame periods FP including a first frame period FP1, a second frame period FP2, . . . , and an N-th frame period FPN are performed during the ranging period. During each frame period FP, a plurality of shot periods SP and a peak determination period PP are executed. In FIG. 3, it is assumed that M-number of shot periods SP including a first shot period SP1, a second shot period SP2, . . . , and an M-th shot period SPM and a peak determination period PP are performed in one frame period FP. Each shot period SP is divided into a plurality of bins divided based on the time count. In FIG. 3, it is assumed that one shot period SP is divided into L-number of bins including bin B1, bin B2, . . . , and bin BL.

One frame period FP corresponds to a period in which one distance image is acquired. In one shot period SP, the pulsed light is emitted from the light emitting unit 10 once. That is, each shot period SP starts from the timing at which the light emitting unit 10 emits the pulsed light, and the length of each shot period SP is defined by the interval at which the pulsed light is emitted. During each shot period SP, a counting operation of counting pulses output from the photoelectric conversion element is performed for each pixel 42 for each bin divided based on a predetermined time count. The pulse signal output from the photoelectric conversion element is, for example, a photon detection pulse signal output from the SPAD.

For counting the time, it is common to use a method of counting pulses of a clock signal oscillating at high speed and at the same cycle using a ring oscillator. When the period of the clock signal is, for example, 0.1 microseconds, it can be seen that 1 microsecond has elapsed as the time count value increases from, for example, 0 to 10. In FIG. 3, it is assumed that the cycle of the clock signal for time counting is sufficiently shorter than the generation frequency of the pulse signal output from the photoelectric conversion element.

In this way, by acquiring the photon count value in each bin of each shot period SP, it is possible to acquire data (histogram information) including information of histograms as illustrated in FIG. 4A to FIG. 4D.

FIG. 4A illustrates an example of the histogram acquired in the first shot period SP1, FIG. 4B illustrates an example of the histogram acquired in the second shot period SP2, and FIG. 4C illustrates an example of the histogram acquired in the third shot period SP3. FIG. 4D illustrates a histogram obtained by integrating the histograms of FIG. 4A to FIG. 4C.

As illustrated in FIG. 4A, the histogram acquired in the first shot period SP1 has a peak of the photon count value in the bin 6. As illustrated in FIG. 4B, the histogram acquired in the second shot period SP2 has peaks of the photon count value in the bin 3 and the bin 5. As illustrated in FIG. 4C, the histogram acquired in the third shot period SP3 has a peak of the photon count value in the bin 6. On the other hand, the histogram obtained by integrating these values has a peak of the photon count value in the bin 6 as illustrated in FIG. 4D. In this way, by integrating the information of the plurality of shot periods SP, it is possible to determine a bin with a higher possibility of reflected light from the distance measurement target.

In the peak determination period PP, the distance to the target object 110 is calculated based on the time information of the bin having the peak photon count value. The distance D [m] to the target object 110 may be calculated by the following Expression (1). Here, t is a time count value (unit: second) acquired from the time counting unit 30 at the timing when the pulse signal is received from the light receiving unit 40, and c is the speed of light (2.998×10⁸ [m/sec]).

$$D = c \times t / 2 [ m ] \qquad ( 1 )$$

For example, when the bins in FIG. 4A to FIG. 4D are set at intervals of 10 nanoseconds, the bin 6 in which the photon count value indicates a peak corresponds to a class for counting pulse signals detected between 50 nanoseconds and 60 nanoseconds after light emission of the light emitting unit 10. Therefore, the distance D to the target object 110 may be calculated as 7.5 [m] to 9.0 [m] from the Expression (1).

In a general LiDAR system, histogram information is generated for each pixel, but in the present embodiment, binning processing is performed in the binning processing unit 60, and histogram information is generated for each pixel group after the binning processing. The processing after generating the histogram information may be similar to the processing in a typical LiDAR system.

Next, the operation of the ranging device according to the present embodiment will be described in more detail with reference to FIG. 5.

When the distance measurement is started, a plurality of frame periods FP are sequentially executed from the first frame period FP1, as described with reference to FIG. 3. When the frame period FP is started, first, in step S101, an initialization processing for starting the frame period FP is performed. That is, in step S101, the variable m representing the number of the shot period SP being processed and the variable 1 representing the bin number being processed are set to 1 which is an initial value.

Next, in step S102, an initialization processing for starting processing in each bin is performed. That is, in step S102, the variable t representing the time count value and the variable PC representing the photon count value are set to 0, which is an initial value.

Next, in step S103, the shot period SPm is started. The shot period SPm is started by emitting pulsed light from the light emitting unit 10 and starting time counting in the time counting unit 30 in synchronization with the emission of pulsed light under the control of the control unit 20. The time counting unit 30 starts counting time from 0 (t=0). The counting of the time may be performed by, for example, a method of counting the clock signal. For example, in the case of using a clock signal having a cycle of 0.1 microseconds, when the time count value increases from 0 to 10, 1 microsecond has elapsed.

Next, in step S104, a photon counting processing in the bin B1 of the shot period SPm is performed. In the photon counting processing, pulses generated by light incident on the photoelectric conversion element of the pixel 42 are counted for each pixel 42. The count result is held in the latch circuit of each pixel 42. The counter included in each pixel 42 may be a one-bit counter, and the photon counting processing may be stopped until the period of the bin has elapsed when the photon count value becomes 1.

Next, in step S105, it is determined whether or not the time count value t has reached a predetermined time count value T determined in advance as a bin interval. As a result of the determination, when the time count value t has not reached the time count value T (“NO” in step S105), the process returns to step S104, and the photon counting processing is continued. As a result of the determination, when the time count value t has reached the time count value T (“YES” in step S105), the bin B1 is ended, and the process proceeds to step S106.

In step S106, the pixel value held in the latch circuit by each pixel 42 is transferred to the binning processing unit 60 via the data transfer unit 50. The binning processing unit 60 performs binning processing on the pixel values received from the light receiving unit 40 for each predetermined pixel block, and transfers the pixel values for each pixel block after the binning processing to the histogram information generation unit 70. Details of the data transfer processing in step S106 will be described later.

Next, in step S107, it is determined whether or not the currently processed bin B1 is the last bin BL among the bins constituting the currently processed shot period SPm. As a result of the determination, when the bin B1 is not the bin BL (1/L: “NO” in step S107), the number 1 of the bin is incremented by 1 and the photon count value PC is initialized to 0 in step S108. Thereafter, the process returns to step S104, and the process of the next bin in the shot period SPm is performed.

As a result of the determination, when the bin B1 is the bin BL (1=L: “YES” in step S107), the shot period SPm is ended, and the process proceeds to step S109.

The pixel value in each bin of each pixel block held in the histogram information generation unit 70 at the time when the shot period SPm ends becomes histogram information in the shot period SPm. The histogram information generation unit 70 stores the acquired histogram information in the histogram information holding unit 80.

In step S109, it is determined whether or not the shot period SPm being processed is the last shot period SPM among the shot periods constituting the frame period FP being processed. As a result of the determination, when the shot period SPm is not the shot period SPM (m/M: “NO” in step S109), the number m of the shot period is incremented by 1 in step S110, the process returns to step S102, and the process of the next shot period SP is performed. As a result of the determination, when the shot period SPm is the shot period SPM (m=M: “YES” in step S109), the process proceeds to step S111.

Next, in step S111, the output unit 90 transfers the histogram information of each shot period held in the histogram information holding unit 80 to the outside of the ranging device.

The information output to the outside may be the histogram information obtained by integrating the histogram information of each shot period for each bin, or may be the information (peak information) related to a bin indicating a frequency peak in the histogram information or the distance information based on the peak information.

Next, in step S112, the control unit 20 determines whether or not to terminate the ranging processing. As a result of the determination, when the distance measurement processing is not ended (“NO” in step S112), the process returns to step S101, and the process of the next frame period is started. As a result of the determination, when the distance measurement processing is ended (“YES” in step S112), the imaging by the light receiving unit 40 is stopped, and the series of distance measurement processing is ended.

Next, an operation example of the light receiving unit 40, the data transfer unit 50, and the binning processing unit 60 in the data transfer processing in step S106 will be described with reference to FIG. 2 and FIG. 6.

The photon count value (pixel value) acquired by the photon count processing in step S104 is held in the latch circuit of each pixel 42. Upon receiving the control signal from the control unit 20, each pixel 42 outputs the pixel value held in the latch circuit to the data transfer unit 50. At this time, by selecting one input terminal on the latch circuit side of the selector 52, the pixel value of each pixel 42 is supplied to the input terminal of the corresponding sequential circuit 54. When the clock signal is input to the clock terminal of each sequential circuit 54 in this state, the pixel value of each pixel 42 is held in the corresponding sequential circuit 54. At this time, if a common clock signal is supplied to each sequential circuit 54, the pixel values of the pixels 42 may be collectively written to the sequential circuits 54 corresponding in parallel. After the pixel value of each pixel 42 is written into the sequential circuit 54, the data of the next bin may be held in the latch circuit of the pixel 42.

After the transfer of the pixel values to the sequential circuits 54 is completed, the other input terminal of the selector 52 is selected, so that the sequential circuit 54 corresponding to the pixels 42 constituting each group constitutes a shift register. In this state, when a common clock signal is supplied to each sequential circuit 54, in each shift register, every time a clock pulse is received, the pixel value held in each sequential circuit 54 is sequentially transferred to the sequential circuit 54 at one stage downstream. By configuring the shift register by the sequential circuits 54 corresponding to the pixels 42 constituting each group, it is possible to easily perform sequential transfer of the signals received from the light receiving unit 40 to the binning processing unit 60.

When the pixel value is transferred to the predetermined sequential circuit 54 on the downstream side of each shift register, the pixel value is input to the binning processing unit 60. In the configuration example illustrated in FIG. 2, the signals a, b, c, and d output from the two sequential circuits 54 on the downstream side of each shift register are input in parallel to the combinational circuit 62 of the binning processing unit 60. By sequentially inputting the number of clock pulses corresponding to the number of pixels 42 constituting each group to each sequential circuit 54, the pixel values of all the pixels 42 may be transferred from the data transfer unit 50 to the binning processing unit 60. The cycle of the clock signal input to the sequential circuits 54 is appropriately set so that the transfer of the pixel values of all the pixels 42 ends before the pixel values of the next bin are transferred to the data transfer unit 50.

The combinational circuit 62 may perform binning processing based on the signals a, b, c, and d from the data transfer unit 50. The combinational circuit 62 may also perform binning processing based on the signals a, b, c, and d and the signal z output from the combinational circuit 62 one clock cycle before by selecting the signal z output from the sequential circuit 66 by the selector 64. Although the binning process performed by the combinational circuit 62 is not particularly limited, a compression processing of four pixels is assumed here. Here, the compression processing is a process of outputting an output result without bit expansion. That is, the bit width of the data processed by the binning processing unit 60 is equal to or less than the bit width of the data input to the binning processing unit 60.

FIG. 6 is a truth table illustrating an example of binning processing in the combinational circuit 62. FIG. 6 illustrates signals a, b, c, d, and z input to the combinational circuit 62 and a signal y output from the combinational circuit 62. Here, an example of binning processing is illustrated in which the signals a, b, c, d, and z are 1-bit signals and 1 is output when three or more of the five inputs are 1.

When the selector 64 selects the input 0, that is, when the signal z output from the combinational circuit 62 one clock period before is not fed back to the input, the combinational circuit 62 outputs 1 when three or more of the signals a, b, c, and d are 1. When the signal z is not fed back, the combinational circuit 62 outputs a result of binning pixel values of a total of four pixels, i.e., pixel blocks of two vertical pixels and two horizontal pixels adjacent to each other. Here, this process is referred to as four-pixel binning.

In a case where the selector 64 selects the signal z, that is, in a case where the signal z output from the combinational circuit 62 one clock period before is fed back to the input, the combinational circuit 62 outputs 1 when the signal z is 1 and two or more of the signals a, b, c, and d are 1. In this case, the information of four pixels in the current clock cycle and the information of four pixels one clock cycle before shifted in the row direction by one pixel are binned. This substantially results in binning information of two vertical pixels and three horizontal pixels. Here, this processing is referred to as 4 pixels×2 binning. As in the configuration example illustrated in FIG. 2, by configuring the combinational circuit 62 for four-pixel binning so as to be able to feed back the binning result of one clock period before, it is possible to expand the binning range while suppressing a significant increase in the circuit scale. Note that the signal z to be fed back to the input does not necessarily have to be the signal z output one clock period before, and may be a signal output two or more clock periods before. That is, the signal z to be fed back to the input may be the signal z output one clock period or more before.

As described above, in the present embodiment, the signals received from the light receiving unit 40 are sequentially transferred to the binning processing unit 60, and are sequentially converted into signals for each pixel block. Accordingly, since the binning processing unit 60 may be shared by a plurality of pixel blocks, it is not necessary to provide the binning processing unit 60 for each pixel block, and it is possible to reduce the circuit scale of the pixel circuit and the peripheral circuit. Therefore, according to the present embodiment, it is possible to improve the distance measurement accuracy while suppressing an increase in memory capacity and processing circuitry required for signal processing.

### Second Embodiment

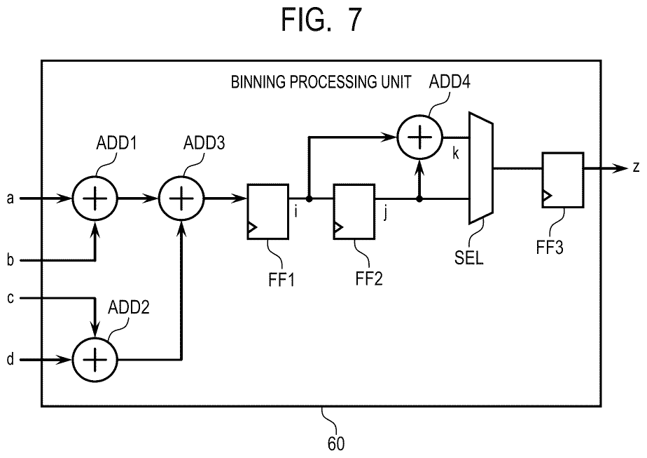

A ranging device and a method of driving the same according to a second embodiment of the present invention will be described with reference to FIG. 7. The same components as those of the ranging device according to the first embodiment are denoted by the same reference numerals, and description thereof will be omitted or simplified. FIG. 7 is a circuit diagram illustrating a configuration example of a binning processing unit in a ranging device according to the present embodiment.

The ranging device according to the present embodiment is the same as the ranging device according to the first embodiment except that the configuration of the binning processing unit 60 is different. In the present embodiment, differences from the first embodiment will be mainly described, and description of points similar to those of the first embodiment will be appropriately omitted.

As illustrated in FIG. 7, the binning processing unit 60 according to the present embodiment includes adders ADD1, ADD2, ADD3, and ADD4, sequential circuits FF1, FF2, and FF3, and a selector SEL. Each of the adders ADD1, ADD2, ADD3, and ADD4 includes two input terminals and one output terminal, adds signals input from the two input terminals, and outputs the added signals from the output terminal. Each of the sequential circuits FF1, FF2, and FF3 is a circuit whose output state is determined by a combination of an external input signal and a held internal state, and may be configured by, for example, a D-type flip-flop. Each of the sequential circuits FF1, FF2, and FF3 includes an input terminal, an output terminal, and a clock terminal, holds a signal of the input terminal in accordance with a transition timing of a clock signal input from the clock terminal, and continuously outputs the signal from the output terminal. The selector SEL includes two input terminals and one output terminal, selects a signal input to one of the two input terminals, and outputs the selected signal from the output terminal.

As in the first embodiment, the signals a, b, c, and d output from the data transfer unit 50 are input to the binning processing unit 60. The signals a and b are input to the adder ADD1, and the signals c and d are input to the adder ADD2. The output terminal of the adder ADD1 is connected to one input terminal of the adder ADD3. The output terminal of the adder ADD2 is connected to the other input terminal of the adder ADD3. The output terminal of the adder ADD3 is connected to the input terminal of the sequential circuit FF1. The output terminal of the sequential circuit FF1 is connected to the input terminal of the sequential circuit FF2 and one input terminal of the adder ADD4. The output terminal of the sequential circuit FF2 is connected to the other input terminal of the adder ADD4 and one input terminal of the selector SEL. The output terminal of the adder ADD4 is connected to the other input terminal of the selector SEL. The output terminal of the selector SEL is connected to the input terminal of the sequential circuit FF3. The output terminal of the sequential circuit FF3 constitutes an output terminal of the binning processing unit 60.

In the binning processing unit 60 of the present embodiment, the adders ADD1, ADD2, ADD3, and ADD4 correspond to the combinational circuit 62 of the first embodiment. The signals a, b, c, and d are added by adders ADD1, ADD2, and ADD3, and held in the sequential circuit FF1 in response to input of a clock pulse to the sequential circuit FF1. The addition data i output from the sequential circuit FF1 is input to the input terminal of the sequential circuit FF2 and one input terminal of the adder ADD4.

At this time, the sequential circuit FF2 holds the binning result (addition data j) one clock cycle before. Therefore, the addition data j is input to one input terminal of the selector SEL, and the addition data k of the addition data i and the addition data j is input to the other input terminal of the selector SEL. By selecting one of the addition data j and the addition data k by the selector SEL, it is possible to output either the 4-pixel binning result or the 4 pixel×2 binning result as in the case of the first embodiment. The addition data output from the selector SEL is held in the sequential circuit FF3 in response to input of a clock pulse to the sequential circuit FF3.

In the present embodiment, from the viewpoint of preventing the added data from becoming enormous, the feedback loop as used in the first embodiment is not used. According to the present embodiment, although it is necessary to expand one bit after data addition, it is possible to reduce the circuit area without compressing data.

As described above, according to the present embodiment, it is possible to improve the distance measurement accuracy while suppressing an increase in memory capacity and processing circuitry required for signal processing.

### Third Embodiment

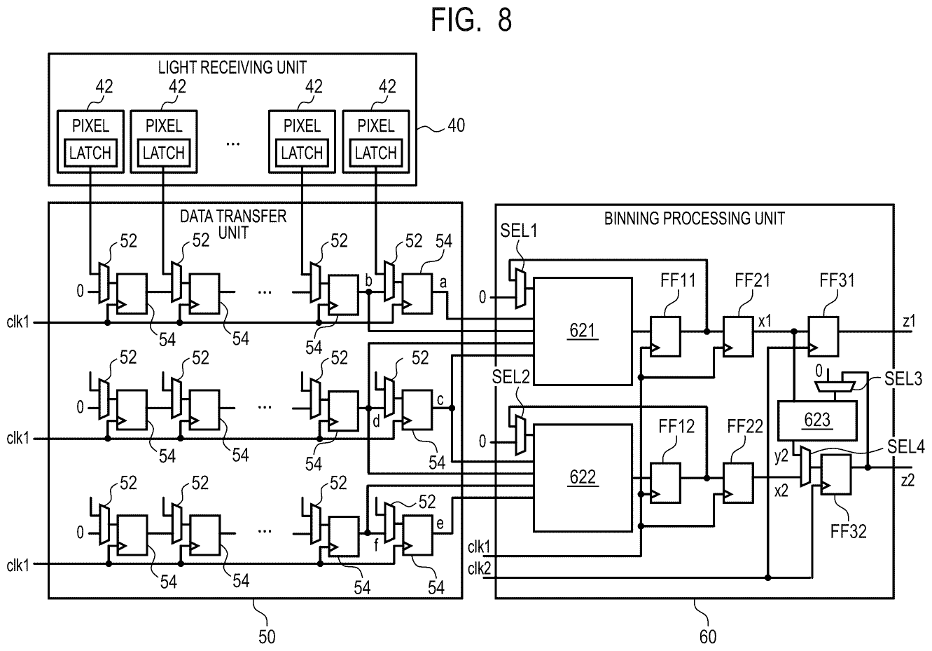

A ranging device and a method of driving the same according to a third embodiment of the present invention will be described with reference to FIG. 8. The same components as those of the ranging device according to the first or second embodiment are denoted by the same reference numerals, and description thereof will be omitted or simplified. FIG. 8 is a circuit diagram illustrating a configuration example of a light receiving unit, a data transfer unit, and a binning processing unit in a ranging device according to the present embodiment.

The ranging device according to the present embodiment is the same as the ranging device according to the first embodiment except that the configuration of the binning processing unit 60 is different. In the present embodiment, differences from the first embodiment will be mainly described, and description of points similar to those of the first embodiment will be appropriately omitted.

As illustrated in FIG. 8, the binning processing unit 60 according to the present embodiment includes combinational circuits 621, 622, and 623, sequential circuits FF11, FF12, FF21, FF22, FF31, and FF32, and selectors SEL1, SEL2, SEL3, and SE14. Each of the selectors SEL1, SEL2, SEL3, and SE14 includes two input terminals and one output terminal, select a signal input to one of the two input terminals, and output the selected signal from the output terminal. Each of the sequential circuits FF11, FF12, FF21, FF22, FF31, and FF32 is a circuit whose output state is determined by a combination of an input signal from the outside and an internal state held therein, and may be formed of, for example, a D-type flip-flop. Each of the sequential circuits FF11, FF12, FF21, FF22, FF31, and FF32 includes an input terminal, an output terminal, and a clock terminal, holds a signal of the input terminal in accordance with transition timing of a clock signal input to the clock terminal, and outputs the signal from the output terminal. Like the combinational circuit 62 of the first embodiment, the combinational circuits 621 and 622 include five input terminals and one output terminal, and output a signal corresponding to signals input from the five input terminals from the output terminal. The combinational circuit 623 includes two input terminals and one output terminal, and outputs a signal corresponding to signals input from the two input terminals from the output terminal.

Among the sequential circuits 54 constituting the data transfer unit 50, the output terminals of the sequential circuits of the predetermined number that is set according to the binning processing in the binning processing unit 60 are connected to the input terminals of the combination circuits 621 and 622. In the present embodiment, it is assumed that the pixels 42 arranged in each row constitute a group forming a shift register, and output terminals of two sequential circuits 54 on the downstream side of two shift registers arranged in adjacent rows are connected to input terminals of the same combinational circuits 621 and 622. Specifically, signals a, b, c, and d output from two sequential circuits 54 on the downstream side of two shift registers arranged in adjacent rows are input to the combinational circuit 621. Signals c, d, e, and f output from two sequential circuits 54 on the downstream side of two shift registers arranged in adjacent rows are input to the combinational circuit 622.

The output terminal of the combinational circuit 621 is connected to the input terminal of the sequential circuit FF11.

The output terminal of the sequential circuit FF11 is connected to one input terminal of the selector SEL1 and the input terminal of the sequential circuit FF21. The output terminal of the selector SEL1 is connected to the input terminal of the combinational circuit 621. The output terminal of the sequential circuit FF21 is connected to the input terminal of the sequential circuit FF31 and one input terminal of the combinational circuit 623. The output terminal of the sequential circuit FF31 is an output terminal of the binning processing unit 60 that outputs the signal z1. The output terminal of the combinational circuit 623 is connected to one input terminal of the selector SEL4.

The output terminal of the combinational circuit 622 is connected to the input terminal of the sequential circuit FF12.

The output terminal of the sequential circuit FF12 is connected to one input terminal of the selector SEL2 and the input terminal of the sequential circuit FF22. The output terminal of the selector SEL2 is connected to the input terminal of the combinational circuit 622. The output terminal of the sequential circuit FF22 is connected to the other input terminal of the selector SEL4. The output terminal of the selector SEL4 is connected to the input terminal of the sequential circuit FF32. The output terminal of the sequential circuit FF32 is connected to one input terminal of the selector SEL3. The output terminal of the selector SEL3 is connected to the other input terminal of the combinational circuit 623. The output terminal of the sequential circuit FF32 is an output terminal of the binning processing unit 60 that outputs the signal z2.

A common clock signal clk1 is supplied to the clock terminals of the sequential circuits 54 of the data transfer unit 50 and the sequential circuits FF11, FF21, FF12, and FF22 of the binning processing unit 60. A common clock signal clk2 is supplied to the sequential circuits FF31 and FF32 of the binning processing unit 60.

As described above, the binning processing unit 60 of the present embodiment includes the combinational circuit 623 between the sequential circuit FF31 that receives the signal from the combinational circuit 621 and the sequential circuit FF32 that receives the signal from the combinational circuit 622. The combinational circuit 623 is provided to expand the binning range in the column direction. In the present embodiment, the sequential circuits FF11, FF21, FF12, and FF22 operate in synchronization with the clock signal clk1, whereas the sequential circuits FF31 and FF32 operate in synchronization with the clock signal clk2. The frequencies of the clock signals clk1 and clk2 may be the same, but in order not to perform the data propagation and binning processing in the row direction and the binning processing in the column direction at the same time, the supply of the other is stopped while one of them is operating.

When performing four-pixel binning, the selectors SEL1 and SEL2 are set so as not to input feedback to the combinational circuits 621 and 622, and the selector SEL4 is set so as to select the signal x2 output from the sequential circuit FF22. Thus, the processing results of the combinational circuits 621 and 622 may be output as the signals z1 and z2, respectively. In this case, the same signal may be used for the clock signals clk1 and clk2, and these may be toggled at the same time.

When 9-pixel binning is performed, the selectors SEL1 and SEL2 are set so as to perform feedback input to the combinational circuits 621 and 622, and the signal y2 is selected one clock period after the signal x2 is selected by the selector SEL4. One clock period later, the signal z2 is output as a binning result. In this case, when the clock signal clk2 performs the toggle operation, the clock signal clk1 does not operate.

Although the four-pixel binning and the nine-pixel binning are described as an example here, binning of 16 pixels or more is also possible by further providing the combinational circuit 623 and the selectors SEL3 and SEL4 so as to connect signals from four or more shift registers in the column direction. The binning range may be freely switched by appropriately switching the operations of the selectors SEL1, SEL2, SEL3, and SEL4.

As described above, according to the present embodiment, it is possible to improve the distance measurement accuracy while suppressing an increase in memory capacity and processing circuitry required for signal processing.

### Fourth Embodiment

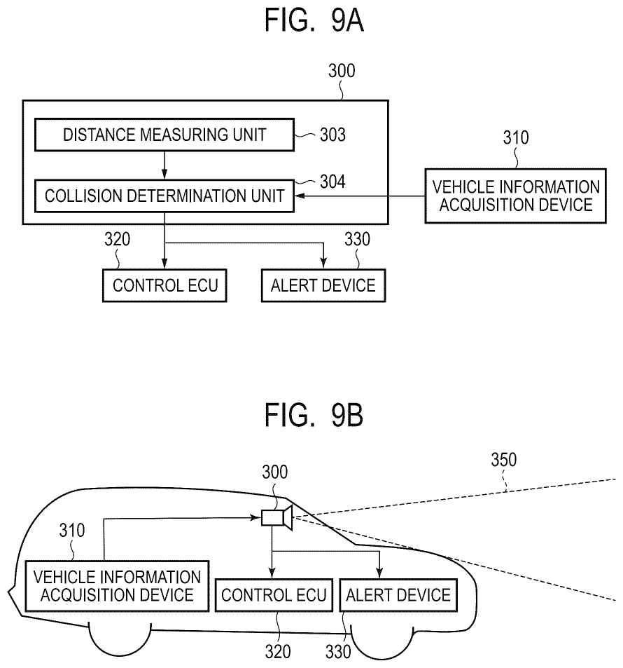

A movable object according to a fourth embodiment of the present invention will be described with reference to FIG. 9A and FIG. 9B. FIG. 9A and FIG. 9B are diagrams illustrating a configuration example of a movable object according to the present embodiment.

FIG. 9A illustrates a configuration example of equipment mounted on a vehicle as an on-vehicle camera. Equipment 300 includes a distance measuring unit 303 that measures a distance to a distance measurement target, and a collision determination unit 304 that determines whether or not there is a possibility of collision based on the distance measured by the distance measuring unit 303. The distance measuring unit 303 may be configured by the ranging device 100 described in any of the first to third embodiments. Here, the distance measuring unit 303 is an example of a distance information acquisition unit that acquires distance information to the distance measurement target. That is, the distance information is information related to the distance to the distance measurement target or the like.

The equipment 300 is connected to the vehicle information acquisition device 310, and may acquire vehicle information such as a vehicle speed, a yaw rate, and a steering angle. In addition, a control ECU 320, which is a control device that outputs a control signal for generating a braking force to the vehicle based on the determination result of the collision determination unit 304, is connected to the equipment 300. The equipment 300 is also connected to an alert device 330 that issues an alert to the driver based on the determination result of the collision determination unit 304. For example, when the determination result of the collision determination unit 304 indicates that the possibility of collision is high, the control ECU 320 performs vehicle control to avoid collision and reduce damage by, for example, applying a brake, returning an accelerator, or suppressing engine output. The alert device 330 gives an alert to the user by sounding an alarm such as a sound, displaying alert information on a screen of a car navigation system or the like, giving vibration to a seat belt or a steering wheel, or the like. These devices of the equipment 300 function as a movable object control unit that controls the operation of controlling the vehicle as described above.

In the present embodiment, the distance measurement of the surroundings, for example, the front or the rear of the vehicle is performed by the equipment 300. FIG. 9B illustrates the equipment in the case of distance measurement in front of the vehicle (distance measurement range 350). The vehicle information acquisition device 310 serving as the distance measurement control unit sends an instruction to the equipment 300 or the distance measuring unit 303 to perform the distance measurement operation. With such a configuration, the accuracy of distance measurement may be further improved.

In the above description, an example in which control is performed so as not to collide with another vehicle has been described, but the present embodiment is also applicable to control in which automatic driving is performed so as to follow another vehicle, control in which automatic driving is performed so as not to protrude from a lane, and the like. Furthermore, the equipment is not limited to vehicles such as automobiles, and may be applied to the other movable objects (mobile devices), for example, ships, aircrafts, artificial satellites, industrial robots, consumer robots, and the like. In addition, the present embodiment is not limited to movable object, and may be widely applied to equipment utilizing object recognition or biological recognition, such as ITS (Intelligent Transport Systems), monitoring system, and the like.

### Modified Embodiments

The present invention is not limited to the above-described embodiments, and various modifications are possible.

For example, examples in which some of the configurations of any of the embodiments are added to other embodiments or examples in which some of the configurations of any of the embodiments are substituted with some of the configurations of the other embodiments are also an embodiment of the present invention.

In the above-described embodiments, the light emitting unit 10 is described as a part of the components of the ranging device 100, but the light emitting unit 10 does not necessarily need to be a part of the configuration of the ranging device 100. The ranging device 100 may include at least the histogram information generation unit 70 as a signal processing unit, and the functions of the histogram information holding unit 80 and the output unit 90 may be provided in an external device different from the ranging device 100.

Further, in the above embodiments, the histogram information is generated using the time count value until the light irradiated on the object is detected by the light receiving unit 40, but the histogram information may be generated by another method. For example, a signal output from the photoelectric conversion element may be counted in a time-division manner at predetermined time intervals, and the counted signal may be converted into histogram information representing a relationship between a distance and a frequency.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to the present invention, it is possible to realize a ranging device and a method of driving the ranging device in which distance measurement accuracy is improved while suppressing an increase in memory capacity and a processing circuit required for signal processing.

This application claims the benefit of Japanese Patent Application No. 2023-135577, filed Aug. 23, 2023, which is hereby incorporated by reference herein in its entirety.

What is claimed is:

1. A ranging device comprising:
a light receiving unit including a plurality of pixels configured to detect light including an irradiation light from a light emitting unit reflected by an object in a measurement target region;
a binning processing unit configured to convert a plurality of signals output from the plurality of pixels into signals of pixel blocks each including a part of the plurality of pixels;
an information generation unit configured to generate information in which each of the signals of the pixel blocks generated by the binning processing unit and a time from light emission of the light emitting unit to light detection are associated with each other; and
a data transfer unit configured to transfer the plurality of signals from the light receiving unit to the binning processing unit,
wherein the data transfer unit is configured to sequentially transfer the plurality of signals received from the light receiving unit to the binning processing unit, and
wherein the binning processing unit is configured to sequentially convert the plurality of signals transferred from the data transfer unit into the signals of the pixel blocks.

2. The ranging device according to claim 1, wherein the data transfer unit includes a plurality of signal holding units configured to be connectable to the plurality of pixels, respectively.

3. The ranging device according to claim 2, wherein the plurality of signals is transferred from the plurality of pixels to the plurality of signal holding units in parallel.

4. The ranging device according to claim 2, wherein the plurality of signal holding units is configured to be connectable so as to form a shift register.

5. The ranging device according to claim 4, wherein the shift register is configured to transfer each of the plurality of signals held in the plurality of signal holding units sequentially to the signal holding unit on a downstream side.

6. The ranging device according to claim 4,
wherein the plurality of pixels is arranged to form a plurality of rows and a plurality of columns, and
wherein the plurality of signal holding units is divided into a plurality of groups each corresponding to the row or the column, and the shift register is configured for each of the plurality of groups.

7. The ranging device according to claim 6, wherein the signal holding units corresponding to the row or the column are divided into two or more groups.

8. The ranging device according to claim 4, wherein the binning processing unit is configured to receive the signals from a predetermined number of the signal holding units on a downstream side of the shift register in parallel.

9. The ranging device according to claim 4,
wherein the part of the plurality of pixels is arranged in two or more rows or columns, and
wherein the binning processing unit is configured to receive signals of the part of the plurality of pixels from the shift registers corresponding to the two or more rows or columns.

10. The ranging device according to claim 4, wherein the shift register is configured sequentially input the signals to the binning processing unit from the signal holding units on a downstream side in response to a clock pulse.

11. The ranging device according to claim 10, wherein the binning processing unit is configured to convert the signals input from the data transfer unit to the signals corresponding to the pixel blocks each time the clock pulse is input.

12. The ranging device according to claim 11, wherein the binning processing unit is configured to generate a signal based on the signal input from the data transfer unit and the signal input from the data transfer unit in response to the clock pulse one clock period or more before.

13. The ranging device according to claim 1, wherein a bit width of data processed by the binning processing unit is equal to or less than a bit width of data input to the binning processing unit.

14. The ranging device according to claim 1, wherein the information generation unit is configured to generate, for each of the pixel blocks, information indicating a relationship between a class determined according to a time from light emission of the light emitting unit to light detection by the light receiving unit and a frequency indicating the number of times the light is detected.

15. A movable object comprising:
the ranging device according to claim 1, and
a control device configured to control the movable object based on distance information acquired by the ranging device.

16. A method of driving a ranging device including a light receiving unit including a plurality of pixels configured to detect light including an irradiation light from a light emitting unit reflected by an object in a measurement target region, a binning processing unit configured to convert a plurality of signals output from the plurality of pixels into signals of pixel blocks each including a part of the plurality of pixels, and an information generation unit configured to generate information in which each of the signals of the pixel blocks generated by the binning processing unit and a time from light emission of the light emitting unit to light detection are associated with each other, the method comprising:
receiving the plurality of signals from the light receiving unit;
sequentially transferring the plurality of signals received from the light receiving unit to the binning processing unit; and
sequentially converting the plurality of signals to be transferred to the binning processing unit to the signals for each of the pixel blocks.
